(19) United States
(12) Patent Application Publication
(10) Pub. No.: US 2026/0235285 A1
(43) Pub. Date: Aug. 13, 2026

(54) BURNER ASSEMBLY AND METHOD FOR OPERATING A BURNER ASSEMBLY

(71) Applicants: Messer Hungarogáz Kft., Budapest (HU); Messer Austria GmbH, Gumpoldskirchen (AT)

(72) Inventors: Martin Demuth, Guntramsdorf (AT); Christian Erich Gaber, Wiener Neudorf (AT); Gyula Palmai, Salgotarjan (HU); Florian Toth, Pfaffstãtten (AT); Philipp Schindler, Au am Leithaberge (AT)

(73) Assignees: Messer Hungarogáz Kft., Budapest (HU); Messer Austria GmbH, Gumpoldskirchen (AT)

(21) Appl. No.: 19/156,541

(22) PCT Filed: Jan. 4, 2024
(86) PCT No.: PCT/EP2024/050179

§ 371 Date: Aug. 14, 2025

(30) Foreign Application Priority Data
Feb. 15, 2023 (DE) 10 2023 103 687.4

(51) Int. Cl. F23D 14/22; C03B 5/235; F23C 1/00; F23C 6/00; F23C 7/00; F23L 7/00; F27D 99/00

(52) U.S. Cl. CPC F23D 14/22; C03B 5/2353; F23C 6/00; F23C 7/008; F23L 7/007; F27D 99/0033; F23C 1/00; F23C 2201/00; F23C 2900/06041; F23C 2900/06043; F23C 2900/9901; F23L 2900/07005; F23L 2900/07006; F27D 2099/0043

(57) ABSTRACT

A burner assembly for enabling a staged combustion has a high-impulse burner having a central fuel feed line and an oxygen feed line arranged coaxially therewith, and has at least one high-impulse oxygen lance which is arranged vertically above the high-impulse burner. A controller allows for switching between a stoichiometric operation of the high-impulse burner and a staged operation, in which at least a portion of the oxygen required for the stoichiometric combustion of the fuel is supplied via the at least one oxygen lance.

### CROSS-REFERENCE TO RELATED APPLICATIONS

The present application is the U.S. national stage application of international application PCT/EP2024/050179, filed Jan. 4, 2024, which international application was published in the German language on Aug. 22, 2024, as International Publication WO 2024/170157A1 . The international application claims priority to German Patent Application No. 10 2023 103 687.4, filed Feb. 15, 2023. The international and German applications are hereby incorporated by reference herein.

### FIELD

The invention relates to a burner assembly for permitting a staged combustion in a furnace chamber. The invention also relates to a method for operating a burner assembly of this type.

### BACKGROUND

A known method for reducing NOx emissions in combustion processes consists in staging the combustion air. In this case, the combustion air is supplied to the flame in two or more partial flows from positions lying spatially far apart from one another. Some of the combustion air is therefore withheld from the main combustion zone, which leads as a rule there to a substoichiometric combustion reaction and, in the case of carbon-containing fuels, to heavy production of carbon monoxide. The resultant comparatively low adiabatic combustion temperature in the main burning zone reduces the formation of thermal nitrogen oxides. In addition, locally present nitrogen oxides are also directly reduced by the carbon monoxide generated. The uncombusted constituent parts of the fuel are post-combusted at a certain distance from the main burning zone by a secondary air flow. The most prominent examples of this type of combustion are boxer furnaces in power plants, in which the combustion air is even split into primary air, secondary air and tertiary air.

Since a large amount of space is required for this type of staged combustion, only large combustion chambers (e.g. steam boilers in power plants) are suitable for this purpose; they are generally not suitable for use in glass melting furnaces, for example. In addition, the local production of large quantities of carbon monoxide is not always desirable for safety reasons, but also because of the disadvantages associated with the product properties.

In contrast to air burners, oxyfuel burners use technically highly pure oxygen as an oxidizer. However, specifically in the case of high-temperature oxyfuel burners, as are used in glass melting furnaces, in which combustion chamber temperatures of 1450° C. and higher are required, very high concentrations of nitrogen oxides also arise here because of the residual nitrogen present in the oxidizer and due to the admission of additional air into the furnace chamber and emissions from the feed materials. It has therefore already been proposed to transfer the staged combustion principle to combustion processes of this type. However, the considerably reduced volumetric flows means that oxyfuel burners are significantly smaller and more compact than air burners, which makes it difficult to accommodate or retrospectively install complex gas distribution systems for staging the oxygen.

EP 0 762 050 A1 and EP 3 366 994 A1 disclose oxyfuel burner assemblies with staged combustion. These have a flat flame burner with an oval outlet opening, from which, as a vertical distance, at least one further, similarly oval outlet lance for secondary oxygen is arranged. Such a multiple oxygen feed makes it possible to change the oxygen flows fed via the burner and outlet lance(s) and to realize different oxygen concentrations in different regions of the furnace chamber. The greater the amount of oxygen guided into outer regions of the furnace chamber, the higher is the staging and thus the nitrogen-oxide-reducing effect. Furthermore, in particular in glass production, a staged combustion, in which an atmosphere rich in carbon monoxide is formed locally because of a reduced concentration of oxygen below the flame, has proven advantageous. The carbon monoxide counteracts foaming in the glass melt and furthermore enables foam which has already been produced to recede.

### SUMMARY

The invention is based on the object of providing an oxyfuel burner assembly which is suitable in particular for use in glass melting furnaces, is capable of staged combustion and, during operation, can provide NOx emission values that are further reduced in comparison to the prior art.

This object is achieved by a burner assembly having the features described herein.

A burner assembly according to the invention, by means of which a staged combustion can be made possible in a furnace chamber, is equipped with a high-impulse burner, which is mounted in a burner block and has a fuel duct and a primary oxygen feed arranged coaxially with respect to the fuel duct, with at least one upper oxygen lance, which leads out of the burner block vertically at a distance above the high-impulse burner, and with a distributor device for distributing an oxygen flow, which is supplied to the burner assembly from an oxygen line, to the primary oxygen feed and to the at least one oxygen lance.

A “high-impulse burner” is intended to refer here to a fuel/oxygen burner which is configured in such a way that, during the operation of the burner, fuel and/or oxygen (oxidant) are/is admitted into a furnace chamber at an outlet speed of at least 50 m/s, preferably at least 100 m/s, particularly preferably at least 150 m/s. The design of the burner as a high-impulse burner leads in the furnace chamber to intensive recirculation which reduces the flame temperature and thus inhibits the formation of NOx. Furthermore, the high outlet speeds promote flow ratios which lead to temporally and spatially fluctuating concentrations of certain gases in the environment of the flame. As explained in more detail below, this circumstance has proven advantageous in particular in the melting of glass and/or in the heating of a glass melt, and therefore the burner assembly according to the invention is preferably intended and suitable for use in glass melting furnaces.

An “oxygen lance” is intended to be understood here as an apparatus, by means of which an oxygen-containing gas, in particular pure oxygen, can be admitted in a stream-like manner into a combustion chamber. The oxygen lances of the burner assembly according to the invention are also preferably configured as high-impulse lances, from which the oxygen is discharged into the combustion chamber at a speed of at least 50 m/s, preferably at least 100 m/s, particularly preferably at least 150 m/s.

“Pure oxygen” is intended to be understood here as meaning a gas which has an oxygen content of at least 90% by vol, preferably at least 99% by vol. The oxidant used in the burner assembly according to the invention, in particular in the high-pulse burner and the at least one oxygen lance, is preferably pure oxygen.

The fuel duct and the oxygen supply are preferably shaped substantially cylindrically, in particular circular-cylindrically, and arranged coaxially with respect to each other, with the fuel duct being able to be arranged within the oxygen feed or, conversely, the oxygen feed being able to be arranged within the fuel feed. To increase the outlet speed, the fuel duct and/or the oxygen feed can be conically shaped in the region of their respective outlet opening into the furnace chamber (burner mouth). The high-impulse burner is preferably guided through the burner block horizontally or at an inclination of less than 10° in relation to the horizontal.

The at least one oxygen lance is preferably guided through the burner block axially parallel to the high-impulse burner or running at an inclination toward or away from the burner axis thereof at an angle of up to 15° and, as seen geodetically, exits from the burner block above the high-pulse burner, i.e., into the furnace chamber. In the same way as the high-impulse burner, the at least one oxygen lance preferably also has a circular or virtually circular cross section.

The distributor device, which is used in addition to a possibly present control section for controlling the supply of the overall flows of fuel and oxygen, has the task of distributing all of the supplied oxygen to the oxygen feed of the high-impulse burner and to the at least one oxygen lance. “Distributing” here means that, in order to set another regular operating mode, the oxygen flows in each case guided through the oxygen feed or the oxygen lance(s) are not switched on or off or changed independently of each other, but rather an oxygen flow supplied as a whole to the burner assembly remains the same even when the operating mood changes and is merely distributed differently to the oxygen feed and the oxygen lance(s). The distributor device is therefore constructed in such a manner that, during the operation of the burner assembly, the oxygen can be entirely or partially diverted from the oxygen feed to the oxygen lance or the oxygen lances, and vice versa; if a plurality of oxygen lances are present, the oxygen flows in each case admitted via the individual lances can preferably also be incorporated in the distribution and varied among each other in the same way.

In particular, it is thus possible to select a first operating mode of the burner assembly according to the invention, in which the oxygen admitted via the high-pulse burner is substantially stoichiometric with respect to the admitted fuel, and a second operating mode, in which a substoichiometric admission takes place via the oxygen feed of the high-pulse burner and the full stoichiometry takes place by admission of oxygen via the at least one oxygen lance arranged above the high-impulse burner. In this second operating mode, below a horizontal plane (called “burner plane” below) running through the mouth opening of the high-pulse burner into the furnace chamber, a low-oxygen atmosphere is formed in which the formation of carbon monoxide is promoted during the operation of the burner. The high speeds of the gases admitted via the high-impulse burner or the oxygen lance lead to spatial and temporal fluctuations of the carbon monoxide content which, in turn, reduce the foaming in a glass melt heated by the burner assembly according to the invention.

In an advantageous refinement of the burner assembly according to the invention, in addition to the at least one upper fuel lance, at least one lower oxygen lance is provided, which exits from the burner block vertically at a distance below the high-impulse burner. This lower oxygen lance is preferably likewise guided through the burner block axially parallel or likewise running at an inclination toward or away from the longitudinal axis of the high-pulse burner at an angle of at maximum 15°, and likewise preferably has a circular or virtually circular cross section. With this refinement, double staging of the admission of oxygen can take place. In this case, the distributor device is preferably designed in such a manner that, in its distribution, it additionally includes the oxygen flow(s) guided through the lower oxygen lance(s). As a result, in particular, a third operating mode of the burner assembly according to the invention can be realized, in which, below the burner plane, an oxygen excess is brought about in the atmosphere of the furnace chamber and is advantageous in particular for heating a feedstock in the furnace chamber.

A compact, but highly efficient embodiment of the burner assembly according to the invention makes provision that the high-impulse burner and in each case an oxygen lance above and below the high-impulse burner lead out of the burner block vertically one above another.

A likewise advantageous embodiment of the invention makes provision that a plurality of upper and/or lower oxygen lances are provided. For example, this involves a number of in each case two to four oxygen lances which preferably each lead along a horizontal line into the furnace chamber and are preferably each arranged symmetrically with respect to the high-impulse burner. An in each case circular-segment-shaped arrangement of the upper and lower fuel lances is likewise possible within the scope of the invention.

Preferably, the vertical distance of the upper and/or the lower oxygen lances from the high-impulse burner (measured as the distance between the respective center axes) at the mouth of the high-impulse burner into the furnace chamber is at least 1.8 times, preferably at least 2.5 times the diameter of the high-impulse burner.

In a particularly advantageous development of the invention, the distributor device has a distribution element, which is connected in terms of flow on the inflow side to the oxygen line and on the outflow side via flow passages to the primary oxygen feed and to the oxygen lance(s), and a distributor disk, which is in the form of a perforated disk, is mounted on the distribution element so as to be rotatable, but lockable in predetermined angular positions. The distributor disk is equipped with flow openings which interact with the flow passages of the distribution element in order to produce a flow connection. The flow openings, which act as an aperture are distributed in a differing number per area on the distributor disk and/or they have different cross sections, such that, by rotation of the distributor disk, the size and/or number of flow openings interacting with a flow passage of the distribution element, and therefore the volumetric flow of oxygen introduced as a whole into said flow passage, can be changed. In this way, the division of an oxygen flow, which flows in from the oxygen line, into partial flows which are guided via the primary oxygen feed and the oxygen lance(s) to the furnace chamber can be varied in a targeted way. The angular position of the distributor disk is adjustable preferably with a servomotor and/or with a hand crank.

In order to be able to adapt to the distributor device to different requirements, the distributor disk is expediently releasably connected to the distribution element, in order optionally to be able to exchange the distributor disk for another distributor disk, which can be mounted on the distribution element and has a different number and/or size and/or geometry flow openings.

The high-impulse burner is designed in particular for use in a glass melting furnace, preferably for operation with a gaseous, hydrocarbon-containing fuel, such as natural gas. However, in an advantageous variant of the invention, the high-impulse burner is designed in such a manner that, instead of natural gas, it can be operated with hydrogen or with any desired hydrogen/hydrocarbon mixture as the fuel. “Hydrogen” is intended to be understood here as meaning a gas which has a hydrogen content of at least 90% by vol, preferably at least 99% by vol.

A preferred method for operating the burner assembly according to the invention is also disclosed.

In this method, a fuel flow through the fuel duct of the high-impulse burner, a primary oxygen flow through the oxygen feed line of the high-impulse burner and a secondary oxygen flow through the at least one upper oxygen lance (and optionally via the at least one lower oxygen lance, if present) are admitted into a furnace chamber, wherein the primary oxygen flow (including a secondary oxygen flow admitted via possibly present lower oxygen lances) has a substoichiometric ratio in relation to the fuel flow, and a at least for achieving a stoichiometric ratio of the fuel and oxygen with respect to the fuel flow is achieved only by feeding in secondary oxygen via the at least one upper oxygen lance. As a result, a region with an oxygen concentration which is too low in relation to stoichiometric ratios is formed in the furnace chamber below the burner plane. In the event of the presence of carbon-containing compounds, for example when a hydrocarbon-containing fuel is used, a region with a high carbon monoxide concentration is then formed there.

According to the invention, the fuel flow and the primary oxygen flow, and also at least the secondary oxygen flow, which is admitted via the at least one upper oxygen lance, are admitted at a speed of at least 50 m/s, preferably at least 100 m/s, particularly preferably at least 150 m/s. Even speeds of above 200 m/s lead, according to the invention, to the result. For a reason which is not yet fully clarified, the high flow speeds lead to the arising region of low oxygen concentration and high carbon monoxide concentration below the burner plane not being fixed in its composition, but being continuously subject to temporal and spatial fluctuations. In particular, while the operation is in progress, the carbon monoxide concentration fluctuates in a given spatial region below the burner plane by 10% to 100% within a few seconds, with an average content of carbon monoxide of at least 100 vpm, preferably at least 1000 vpm, being sought. As a result, in particular during use in a glass melting furnace, the foaming of a glass melt is more greatly reduced than would be the case in the event of a fixed, carbon monoxide-rich atmosphere having a carbon monoxide content corresponding to the above-mentioned average carbon monoxide content. For this reason, the use of the method according to the invention in a glass melting furnace is particularly preferred.

Preferably, at least most, for example at least 60%, of the oxygen admitted in total into the furnace chamber is admitted as secondary oxygen via the upper oxygen lance(s) and/or the lower oxygen lance(s); the primary oxygen flow is therefore smaller than the secondary oxygen flow or is entirely omitted. In this manner of operation, the NOx emissions during the use of the burner assembly according to the invention are particularly low.

### BRIEF DESCRIPTION OF THE DRAWINGS

An exemplary embodiment of the invention will be explained in more detail with reference to the drawings, in which, in schematic views:

FIG. 1 shows a burner assembly according to the invention in longitudinal section,

FIG. 2 shows the burner assembly from FIG. 1 in a front view, as seen from the direction B in FIG. 1,

FIG. 3a shows a distributor device for distributing the oxygen of a burner assembly according to the invention, in longitudinal section,

FIG. 3b shows the distributor device from FIG. 3a in cross section along the line B-B in FIG. 3a, and

FIG. 3c shows a distributor disk, which is arranged in the distributor device from FIG. 3a, in a top view.

### DETAILED DESCRIPTION

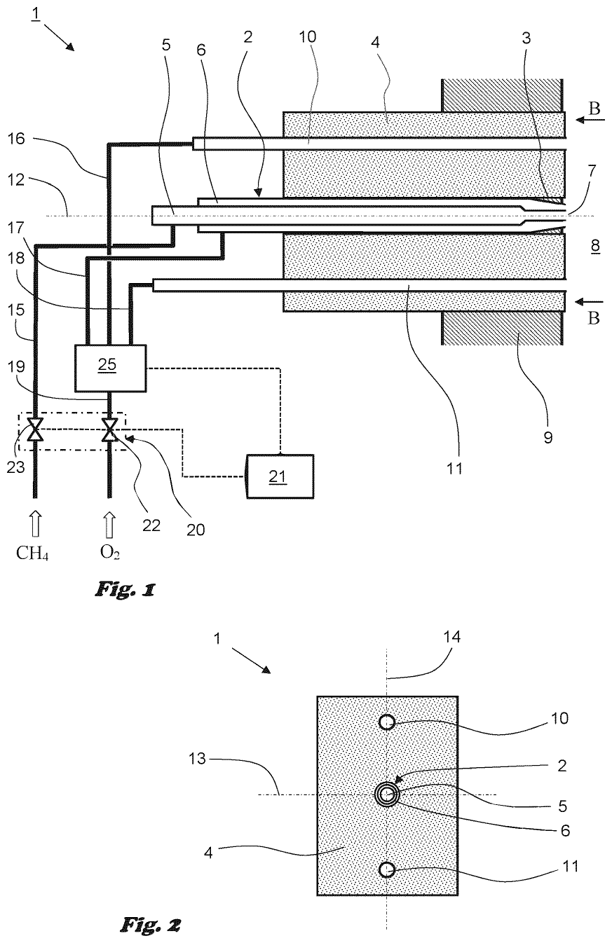

The burner assembly 1 illustrated in FIG. 1 has a high-impulse burner 2 accommodated in a passage 3 of a burner block 4. The high-impulse burner 2 has a cylindrical, central fuel duct 5 and an oxygen feed 6, which is arranged coaxially around the latter, for feeding in primary oxygen. The fuel duct 5 and oxygen duct 6 lead at the burner mouth 7 of the high-impulse burner 2 into a furnace chamber 8, which is, for example, a glass melting furnace. The burner block 4 is mounted in a suitable passage in the wall 9 of the furnace chamber 8.

The high-impulse burner 2 is a burner, in which a flow of a gaseous fuel and the flow of an oxidant are admitted into the furnace chamber 8 at a flow speed of at least 50 m/s, preferably at least 100 m/s, particularly preferably at least 150 m/s. In the case of a high-impulse burner 2 of this type, the high speed of the admitted gases leads to an intensive recirculation of the combustion gases present in the furnace chamber, which results, inter alia, in a reduction of the temperature of the flame (not shown here) forming in the furnace chamber 8. In order to achieve a particularly high outlet speed, the fuel duct 6 and/or oxygen feed 6, as shown here, in the region of the burner mouth 7, can have a flow cross section tapering conically in the direction of the furnace chamber 8.

In order to permit a staged combustion, the burner assembly 1 has oxygen lances 10, 11 for introducing secondary oxygen, which oxygen lances, in the exemplary embodiment, are guided through the burner block 4 axially parallel to the burner axis 12 of the high-impulse burner 2. An upper oxygen lance 10 is arranged and the vertical distance from a horizontal plane (burner plane) 13 running through the axis of the high-impulse burner 2, while a lower oxygen lance 11 is arranged vertically below the burner plane 13. The vertical distance of the oxygen lances 10, 11 from the high-impulse burner 2, as measured from the respective center axes, should in each case be at least 1.8 times the diameter of the high-impulse burner 2 at the burner mouth 7.

In the exemplary embodiment, the oxygen lances 10, 11 are likewise high-impulse admission systems, i.e., the oxygen flow admitted into the furnace chamber 8 by the oxygen lances 10, 11 has a speed of likewise at least 50 m/s, preferably at least 100 m/s, particularly preferably at least 150 m/s.

In the exemplary embodiment shown here, an oxygen lance 10, 11 is in each case arranged above and below the high-impulse burner 2 one above the other in a vertical plane 14. However, within the scope of the invention, it is also conceivable for a plurality of oxygen lances 10 (not shown here) to be provided above and/or below the burner 2; they can be arranged, for example, along a horizontal line or in another way, for example annually around the high-impulse burner 2.

The fuel duct 5 is connected in terms of flow via a fuel line 15 to a source, not shown here, for a gaseous fuel, for example natural gas. The oxygen feed 6 and the oxygen lances 10, 11 are connected in terms of flow via a connecting line 16, 17, 18 to an oxygen line 19 which, in turn, is connected to a source, likewise not shown, for an oxidant, for example pure oxygen.

A control section 20 which is connected in terms of data to and, for example, electronic control system 21 is arranged in the fuel line 15 and the oxygen line 19. Control valves 22, 23 are provided in the control section 20 and are used, depending on predetermined parameters, such as, for example, a temperature measured in the furnace chamber 8, to be able to control the flow quantities of fuel and oxygen admitted as a whole into the furnace chamber 8.

Furthermore, a distributor device 25 is provided in the oxygen line 19 and can be used to variably divide an oxygen flow, conducted via the oxygen line 19, between the connecting lines 16, 17, 18 and therefore between the oxygen feed 6 and the oxygen lances 10, 11. The distributor device 25 can be controlled manually or by means of the control system 21, as explained in more detail by way of example below.

During the operation of the burner assembly 1, a flow of a gaseous fuel is admitted at the previously described high speed into the furnace chamber 8 via the fuel line 15 and the fuel duct 5. The fuel used is, for example, a hydrocarbon-containing gas, such as natural gas, or a hydrogen-containing gas or a mixture of both. At the same time, a flow of pure oxygen, which is preferably stoichiometric or slightly super-stoichiometric with respect to the fuel flow, is conducted via the oxygen line 19. The oxygen flow is completely divided in the distributor device 25 between the connecting lines 16, 17, 18 and passes via the oxygen feed 6 and the oxygen lances 10, 11 into the furnace chamber 8. It is ignited there with the fuel flow, with a flame (not shown here) being formed in the furnace chamber 8.

The following modes of operation are preferred:
a) At least most of the oxygen is conducted to the oxygen feed 6. The fuel and primary oxygen flows introduced into the furnace chamber 8 at the burner mouth 7 of the high-impulse burner 2 are therefore at least virtually stoichiometric to each other. No or at most a small oxygen flow is admitted via the oxygen lances 10, 11, the oxygen flow serving merely to cool the oxygen lances 10, 11 and, by means of the high impulse of the flame, being recirculated into the latter and therefore to a small extent also contributing to the combustion of the fuel in the furnace chamber 8. This operating mode is preferred, for example, when starting the high-impulse burner 2 or for heating the furnace chamber 2.
b) Most of the oxygen is admitted into the furnace chamber 8 via the upper fuel lance 10 (single-stage combustion). A smaller residual flow is introduced via the oxygen feed 6 merely for the purpose of stabilising the flame forming in front of the burner mouth 7. No or at most a small oxygen flow is admitted via the oxygen lance 11, the oxygen flow serving merely to cool the oxygen lance 11 and only slightly contributing to the combustion of the fuel in the furnace chamber 8. In this operating mode, the combustion below the burner plane 13 is overall substoichiometric. As a result, carbon monoxide is formed to a great extent in this region, and, when the burner assembly 1 is used in a gas melting furnace, suppressing the foaming on the glass melt or causing phone which is already formed to recede.
c) All of the oxygen or most of the oxygen is admitted via the oxygen lances 10, 11 into the furnace chamber 8 (two-stage combustion), wherein, also in this case, by varying the distribution of the oxygen flows admitted via the upper fuel lance 10 and the lower fuel lance 11, oxygen-rich and oxygen-poor atmosphere regions can be formed above and below the burner plane 13. A possible small residual flow is introduced via the oxygen feed 6 merely for the purpose of cooling the high-impulse burner 2 (if required) and/or for stabilizing the flame. In this operating mode, the high-impulse burner 2 is therefore operated significantly substoichiometrically or even only as a fuel feed. In this operating mode, a particularly small amount of nitrogen oxides is produced.

These operating modes can, of course, also be used if, instead of the burner assembly 1 shown here with a respective oxygen lance 10, 11 above and below the burner plane 13, use is made of a burner assembly according to the invention having a plurality of oxygen lances above and/or below the burner plane 13.

It has surprisingly turned out that, in the operating mode of the single-stage combustion (operating mode b) with the above-mentioned high outlet speeds of fuel and oxygen, the carbon monoxide excess arising below the burner plane 13 does not form a fixed, i.e., temporally and spatially substantially constant formation, but rather fluctuates temporally and spatially, even in the event of a uniform admission of fuel and oxygen. This effect, which possibly-without the invention in any way intended to be restricted by this-can be attributed to turbulent flow processes in the boundary areas between the admitted flows of oxygen and fuel and the recirculating furnace gases, is all the more pronounced, the higher the outlet speed is of the combustion gases admitted into the furnace chamber 8. This fluctuation can be within a given spatial range of between 10% and 100% of the carbon monoxide concentration measured on average in said spatial region. However, the temporal and spatial fluctuation of the carbon monoxide content in the furnace chamber 8 below the burner level 12 leads to an improved reduction in the foaming of a glass melt located in the furnace chamber 8.

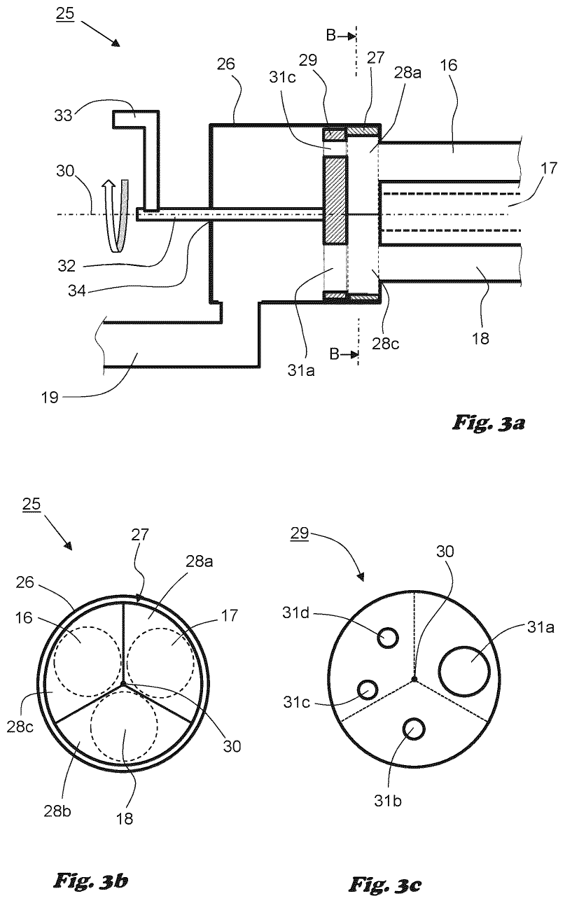

With reference to FIGS. 3a to 3c, a simple, robust and cost-effective possibility will now be described in order to be able to distribute the oxygen flow conducted via the oxygen line 19 to the connecting lines 16, 17, 18 in a desired w. The distributor device 25 here comprises a housing 26 in which a distribution element 27 is fixedly mounted. The distribution element 27 is a perforated plate with three flow passages 28a, 28b, 28c which, in turn, are connected in terms of flow to the connecting lines 16, 17, 18. In the exemplary embodiment shown here, the flow passages 28a, 28b, 28c are each equally sized, circular-segment-shaped openings; however, other geometries and/or size ratios between the flow passages 28a, 28b, 28c are just as conceivable within the scope of the invention.

On the distribution element 27 and coaxially with respect thereto, a distributor disk 29 is mounted rotatably about an axis 30 which is perpendicular to the surface of the distributor disk 29. Said distributor disk is also in the form of a perforated disk and is provided with flow openings 31a, 31b, 31c, 31d. The flow openings 31a, 31b, 31c, 31d are spaced apart from one another in the circumferential direction and, in the exemplary embodiment shown here, each have different cross sections; alternatively or additionally thereto, a different number of flow openings 31a, 31b, 31c, 31d can also be provided in different regions of the same surface of the distributor disk 29. The distributor disk 29 is connected via a shaft 32 to a drive arranged outside the housing 26, for example to a hand crank 33 and/or a stepper motor (not shown here) which, in turn, can be connected in terms of data to the control system 21.

In the position shown in FIG. 3a, the distribution element 27 and distributor disk 29 are arranged in such a manner that the flow passage 28a and the flow opening 31a and also the flow passage 28c and the flow opening 31c come to lie one above the other and in this way produce a flow connection between the oxygen line 19 and the connecting line 17 or 16 (in this position of the distributor disk 29, there are further flow connections, not visible here, between the oxygen line 19 and the connecting line 18 via the flow passage 28 b and the flow opening 31 b and also between the oxygen line 19 and the connecting line 16 via the flow passage 28 c and the flow opening 31d).

The housing 26 receiving the distribution element 27 and the distributor disk 29 is intended to ensure that all of the oxygen conducted via the oxygen line 19 passes through the flow openings 31a, 31b, 31c, 31d in the distributor disk 29 and the flow passages 28a, 28b, 28c in the distribution element 27 into the connecting lines 16, 17, 18. It is consequently connected gas-tightly, for example via flange connections, to the oxygen line 19 and the connecting lines 16, 17, 18 and has a gas-tight passage 34 for the shaft 32.

Owing to the different opening cross section of the flow openings 31a, 31b, 31c, 31d and/or the number of flow openings 31a, 31b, 31c, 31d per unit of area in the distributor disk 29, rotation of the distributor disk 29 about the axis 30 causes the oxygen flow conducted out of the oxygen line 19 to be distributed differently between the connecting lines 16, 17, 18 and therefore between the oxygen feed 6 and the oxygen lances 10, 11. Given a suitable design of the distributor disk 29 with, for example, differently sized flow openings 31a, 31b, 31c, 31d spaced apart from one another in the circumferential direction, it is therefore possible, for example, for the above-described operating modes to be set in a simple way; in particular, for this purpose, the operation of the burner assembly 1 does not need to be interrupted nor the oxygen flow conducted via the oxygen line 19 changed.

The distributor disk 29 shown here with flow openings 31a, 31b, 31c, 31d is furthermore merely one example of a possible distributor disk 29. The flow openings 31a, 31b, 31c, 31d of the distributor disk 29 are preferably designed in such a manner that the pressure loss of the burner assembly 1 as a whole also remains substantially constant during the switching over of the distributor disk 29 and therefore the switching over does not have any effect on the operation of the control section 20. The geometries suitable for this purpose and/or the required number of flow openings 31a, 31b, 31c, 31d in the distributor disk 29 depend in particular on the respectively intended oxygen flows and should be determined individually, for example empirically, for each burner assembly 1 or each furnace chamber 8.

In order to be able to adapt the distributor device 25 to different requirements, the distributor disk 29 is preferably connected releasably to the distribution element 27, and the housing 26 can be opened, in a manner not shown here, in order, when required, to be able to exchange the distributor disk 29 for another distributor disk having a different number and/or size and/or geometry of the flow openings present therein.

### LIST OF REFERENCE SIGNS

1 burner assembly
2 high-impulse burner
3 passage
4 burner block
5 fuel duct
6 oxygen feed
7 burner mouth
8 furnace chamber
9 wall
10 oxygen lance
11 oxygen lance
12 burner axis
13 burner plane
14 vertical plane
15 fuel line
16 connecting line
17 connecting line
18 connecting line
19 oxygen line
20 control section
21 control system
22 control valve
23 control valve
24 —
25 distributor device
26 housing
27 distribution element
28a, 28b, 28c flow passage
29 distributor disk
30 axis
31a, 31b, 31c, 31d flow opening
32 shaft
33 hand crank
34 passage

1. A burner assembly for permitting a staged combustion in a furnace chamber, the burner assembly comprising:
a high-impulse burner, which is mounted in a burner block and has a fuel duct and a primary oxygen feed arranged coaxially with respect to the fuel duct;
at least one upper oxygen lance, which leads out of the burner block vertically at a distance above the high-impulse burner; and
a distributor device for distributing an oxygen flow, which is supplied to the burner assembly from an oxygen line to the primary oxygen feed and to the at least one oxygen lance.

2. The burner assembly as claimed in claim 1, further comprising at least one lower oxygen lance, which leads out of the burner block vertically at a distance below the high-impulse burner.

3. The burner assembly as claimed in claim 1, wherein the high-impulse burner and in each case an upper oxygen lance of the at least one upper oxygen lance and a lower oxygen lance lead out of the burner block vertically one above another.

4. The burner assembly as claimed in claim 1, wherein a plurality of upper and/or lower oxygen lances are provided which lead out of the burner block at a distance from the high-impulse burner.

5. The burner assembly as claimed in claim 4, wherein the vertical distance of the upper and/or the lower oxygen lances from the high-impulse burner at the exit from the burner block is at least 1.8 times, the diameter of the high-impulse burner.

6. The burner assembly as claimed in claim 1, wherein:
the distributor device has a distribution element which is connected in terms of flow on an inflow side to the oxygen line and on an outflow side via flow passages to the primary oxygen feed and to the at least one upper oxygen lance;
the burner assembly further comprises a distributor disk, which is in the form of a perforated disk, and which is mounted on the distribution element so as to be rotatable, but lockable in predetermined angular positions, and which is equipped with flow openings which interact with the flow passages of the distribution element in order to produce a flow connection; and
the flow openings are differently distributed on the distributor disk and/or have different flow cross sections, such that, when the distributor disk is rotated by a predetermined angle, a predetermined distribution of an oxygen flow flowing in from the oxygen line to the primary oxygen feed and to the at least one upper oxygen lance takes place.

7. The burner assembly as claimed in claim 6, wherein the angular position of the distributor disk is adjustable with a servomotor and/or with a hand crank.

8. The burner assembly as claimed in claim 6, wherein the distributor disk is releasably connected to the distribution element.

9. The burner assembly as claimed in claim 1, wherein the high-impulse burner is operable with hydrogen or a hydrogen-containing gas as the fuel and with pure oxygen as the oxidant.

10. A method for operating a burner assembly as claimed in claim 1, in which a fuel flow through the fuel duct, a primary oxygen flow through the oxygen feed line and a secondary oxygen flow through the at least one upper oxygen lance are admitted into a furnace chamber, wherein the primary oxygen flow has a substoichiometric ratio in relation to the fuel flow, and stoichiometric ratio of the fuel and oxygen with respect to the fuel flow is achieved by feeding in secondary oxygen via the at least one upper oxygen lance, wherein the fuel flow, the primary oxygen flow, and the secondary oxygen flow, which is admitted via the at least one upper oxygen lance, are admitted into the furnace chamber at a speed of at least 50 m/s.

11. The method as claimed in claim 10, wherein at least most of the oxygen admitted in total into the furnace chamber is admitted as secondary oxygen via the at least one upper oxygen lance and/or via at least one lower oxygen lance.

12. The method as claimed in claim 10, wherein the burner assembly is configured to be used for heating the furnace chamber of a glass melting furnace.
